(19) United States
(12) Patent Application Publication
(10) Pub. No.: US 2018/0036906 A1
(43) Pub. Date: Feb. 8, 2018

(54) Blade Guard Having a Safety Feature

(71) Applicants: Robert Bosch Tool Corporation, Broadview, IL (US); Robert Bosch GmbH, Stuttgart (DE)

(72) Inventor: Andrew Frolov, Glenview, IL (US)

(21) Appl. No.: 15/230,043

(22) Filed: Aug. 5, 2016

(51) Int. Cl. B27G 19/02; B27G 19/08; B27B 5/38; B26D 7/24; B23Q 11/00

(52) U.S. Cl. CPC B27G 19/02; B26D 7/24; B23Q 11/0082; B27B 5/38; B27G 19/08

(57) ABSTRACT

A safety system is provided for a power tool having a motor-driven cutting blade, a safety mechanism operable by a controller to stop and/or move the cutting blade and a blade guard. The safety system includes an electrically active surface provided on the blade guard that is configured to change an electrical characteristic in response to contact between the body of an operator and the active surface. An active surface controller is operable to provide electrical power to the electrically active surface, to generate a signal in response to the change in the electrical characteristic, the signal indicative of an unsafe condition, and to transmit the signal to the controller for the safety mechanism.

### FIELD

This disclosure relates to power tools that incorporate a guard to protect the operator from the working tool. In particular, the disclosure relates to table saws that incorporate a blade guard to help prevent operator access to the saw blade during operation.

### BACKGROUND

Power tools, such as table saws, incorporate various features to prevent contact between the tool operator and the moving saw blade. Thus, as shown in FIG. 1, a table saw 10 includes a blade assembly 12 that is driven by a drive motor assembly 14 supported on a base 11. As part of the safety feature, the blade assembly 12 of the table saw 10 includes an adjustable riving knife 16 that protects the back edge of the rotating cutting blade 13. A blade guard assembly 20 is mounted to the riving knife 16, such as by way of a mounting fork 30, and incorporates a blade guard 22 that is formed by a frame structure 24.

The blade guard 22 is pivotably mounted to the mounting fork 30 at a pivot mount 34 so that the blade guard can be pivoted in the direction D between its upward position shown in FIG. 1 and its operative position (not shown) adjacent the cutting blade 13. The blade guard 22 further defines a guide slot 26 that receives a guide pin 36 of the mounting fork 30 so ensure proper positioning of the blade guard 22 as it pivots in the direction D, as shown in more detail in FIG. 2. The frame structure 24 includes side walls 24a, 24b that are spaced apart to form a channel 24c configured so that the side walls 24a, 24b flank the sides of the rotating blade 13 during operation. The frame structure 24 further includes a curved leading end 24d that is adapted to contact a workpiece as it is advanced toward the cutting blade to pivot the blade guard upward while remaining in contact with the workpiece as the workpiece advances. The riving knife 16 and the blade guard 22 combine to effectively shroud the cutting blade during operation.

As a further safety feature, the blade assembly 12 and/or the drive motor assembly 14 can incorporate an emergency safety mechanism 48 that is operable to stop and/or retract the cutting blade 13 within the base 11. This safety feature can be invoked when the operator's body is within proximity of or contacts the cutting blade 13. Examples of such safety mechanisms\ can be found in the following U.S. Patents, the disclosures of which are specifically incorporated herein by reference: U.S. Pat. Nos. 8,316,747; 8,291,797; and 8,186,256.

Some prior safety systems include components for detecting the presence of the operator's body in the vicinity of the cutting blade. For instance, U.S. Patent Nos. 8,291,797 and 8,186,256, incorporated by reference above, disclose a detection subsystem that includes detection electrodes capacitively coupled to the saw blade to detect contact between the operator's body and the rotating blade. One problem with these systems is that the operator must still contact the moving blade in order to actuate the safety system. Other systems utilize optical transmitters and detectors to determine whether the operator's body has traversed an optical beam that delineates a “safe” zone around the cutting blade. Systems using optical beams can signal a false condition when debris interferes with the optical beam.

There is always a need for an improved safety system for power tools, such as table saws.

### SUMMARY

A table saw includes a blade assembly driven by a motor assembly supported on a base. The blade assembly and/or the motor assembly are provided with a safety mechanism that neutralizes a dangerous condition based on the proximity of the operator's body to the blade assembly. The blade assembly includes a riving knife and a blade guard assembly supported on the riving knife. The blade guard assembly includes a blade guard formed by a frame structure configured to flank the sides of the cutting blade during operation. The frame structure includes electrically active surfaces exposed to the operator. A control unit provides power to the electrically active surfaces and generates a signal when the electrical characteristic of any of the surfaces is modified. The signal is provided to a main controller that is operable to activate the safety mechanism upon receipt of the signal.

### DESCRIPTION OF THE DRAWINGS

FIG. 1 is a side view of a table saw incorporating the blade guard assembly and safety system disclosed herein.

FIG. 2 is an exploded component view of the drive motor assembly, main controller and blade guard assembly of the table saw shown in FIG. 1.

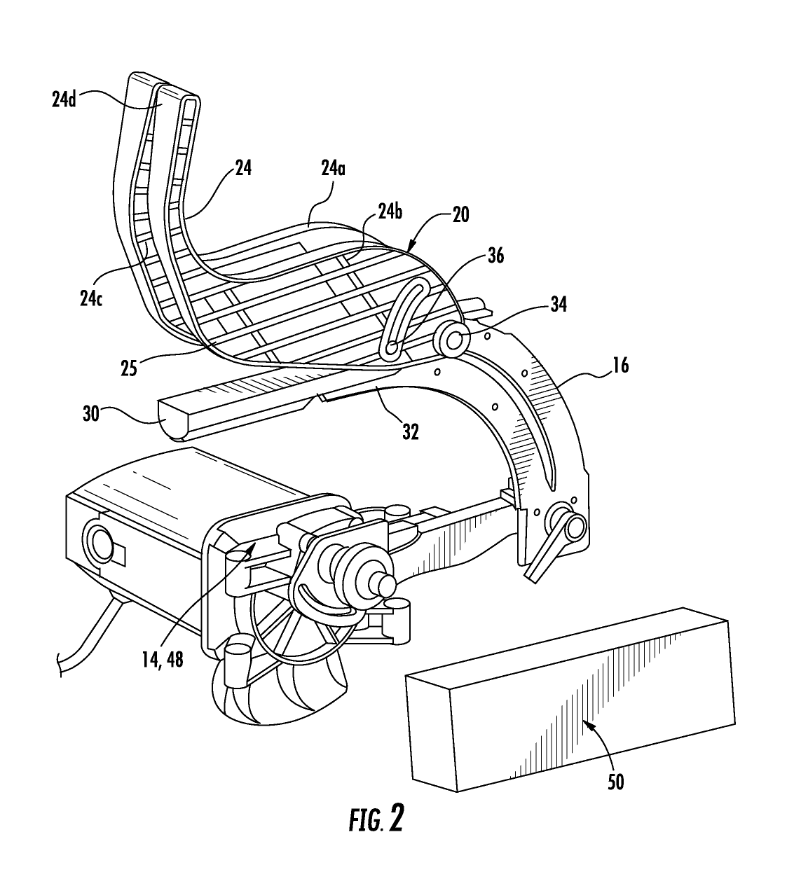

FIG. 3 is an enlarged perspective view of the underside of the blade guard assembly shown in FIG. 2 according to one aspect of the present disclosure.

FIG. 4 is a flowchart of operation of the main controller for the safety mechanism shown in FIGS. 1-2.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertain.

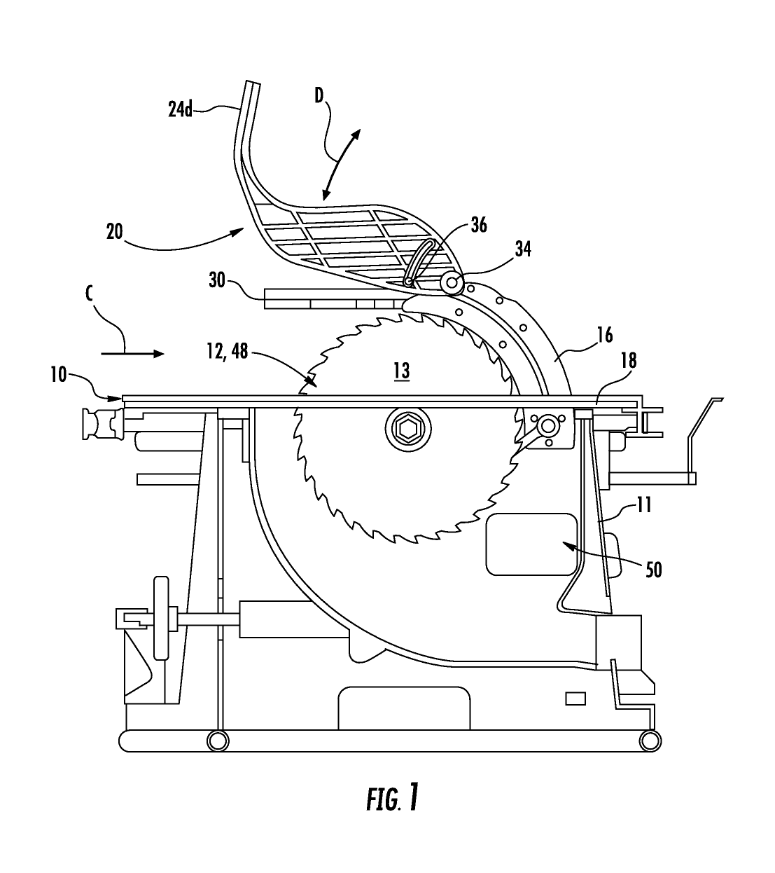

The present disclosure contemplates a safety system that is precisely actuated when the operator's body is dangerously near the cutting blade of the blade assembly, such as the blade assembly 12 of the table saw 10 shown in FIG. 1. The blade assembly 12 and/or the drive motor assembly 14 include a safety mechanism 48 operable to stop the cutting blade 13 and/or to move the cutting blade 13 away from the proximity of the operator's body, such as by retracting the blade below the work surface 18 of the table saw 10. The table saw 10 is provided with a main controller 50 that is coupled to the safety mechanism 48 is operable to actuate the safety mechanism immediately when a dangerous condition is indicated. It can be appreciated that for the purposes of the present disclosure the safety mechanism 48 can be any type of mechanism that immediately stops the cutting blade or that immediately retracts the cutting blade below the work surface, or both.

During normal operation of the table saw, the rotating saw blade 13 is protected by the riving knife 16 and the blade guard 22. However, the leading edge of the saw blade 13 cannot be covered, otherwise the workpiece could not be advanced to the blade. The leading edge of the saw blade is thus susceptible to compromise by the operator's body, such as the operator's hands as he/she advances the workpiece along the work surface 18 in the direction C. The blade guard 22 is not sufficient to prevent the operator's hands from advancing to the cutting blade, since the blade guard must be able to pivot upward in the direction D. Thus, in prior table saws, simply contacting the blade guard is insufficient to prevent the operator form contacting the rotating cutting blade.

The present disclosure contemplates providing the blade guard with electrically active surfaces 25 in the outer face of the frame structure 24. The side walls 24a, 24b and leading end 24d are thus provided with electrically active surfaces 25. The surfaces 25 are configured so that contact by the operator's body causes a change in the electrical characteristics of the surface. The surface may be a capacitive surface in which an electrostatic field is applied to the surface and disruption of that field by contact with the operator results in a change in capacitance of the surface 25. The electrically active surface of this type can operate by surface capacitance or by projected capacitance. Alternatively, the electrically active surface may incorporate a resistive surface in which pressure on an energized outer layer causes the outer layer to contact an inner conductive layer, resulting in the voltage on the inner layer. Other electrically active surfaces are contemplated that produce a signal responsive to contact of the surface by the operator's body. The active surface 25 may be provided in the form of a wire mesh or an electrically active coating.

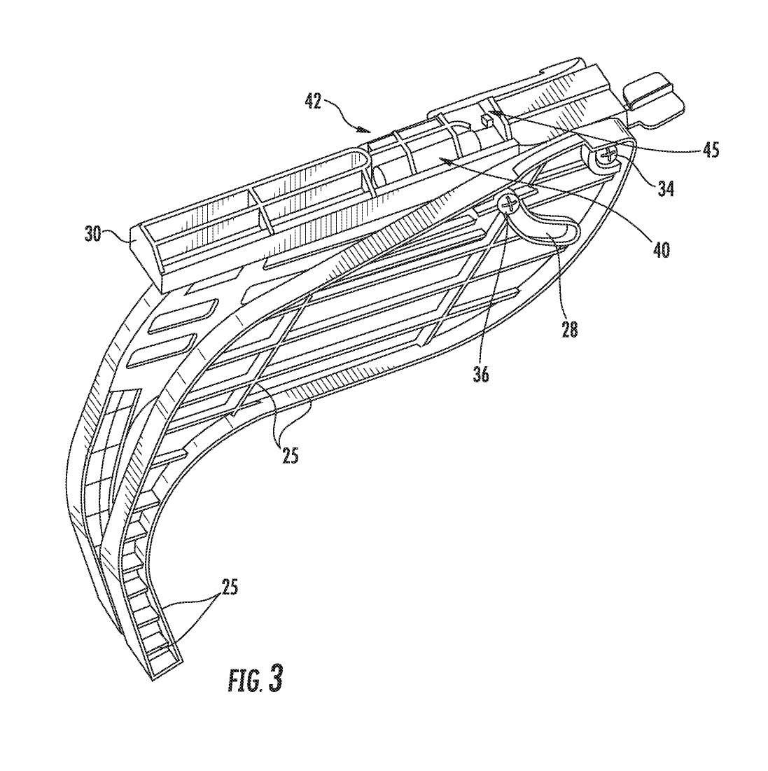

The blade guard assembly 20 includes a power supply 40 and controller 42 mounted within the blade guard mounting fork 30, as shown in FIG. 3. The power supply 40 is electrically connected to the active surfaces 25 to generate an electrostatic field (capacitive surface) or a surface voltage (resistive surface). The power supply may be a replaceable or rechargeable battery, or may be a power transformer connectable to an external electrical source.

The power supply provides power to the active surfaces through the controller 42, and the controller 42 is configured to monitor the relevant electrical characteristic of the electrically active surfaces 25. Thus, in the case of a capacitive surface, the active surface controller 42 continuously measures the capacitance of the active surfaces, either collectively as a single surface or individually as a series of separate surfaces. The controller 42 may be configured to compare the measured capacitance to a predetermined value or may monitor for a change in the capacitance irrespective of the magnitude of the measured capacitance. If the electrically active surface is a resistive surface, the controller 42 may be configured to monitor the inner layer for a voltage.

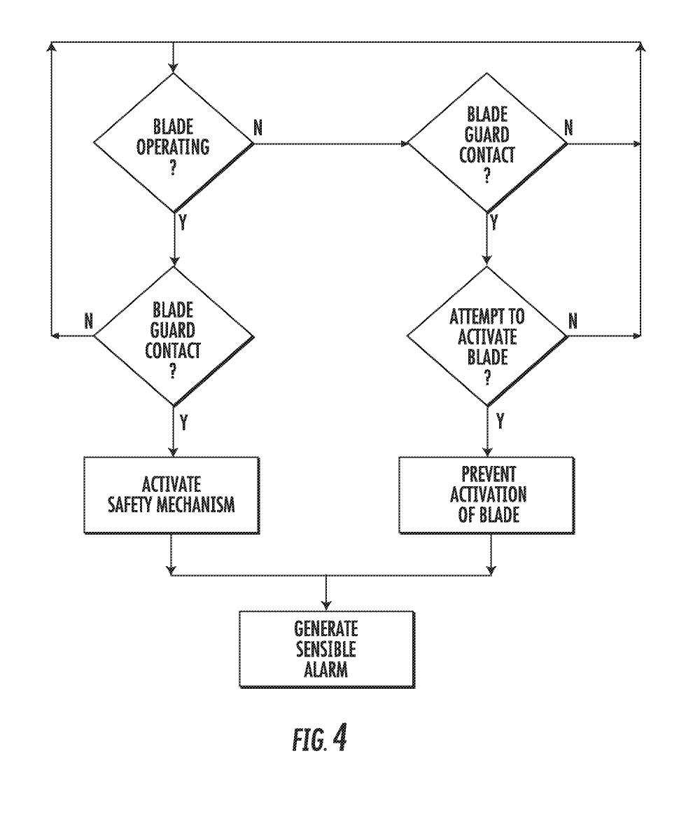

The active surface controller 42 is configured to sense a change in the relevant electrical characteristic of the electrically active surface 25 and to generate a signal in response to such change. This signal is provided to the main controller 50, and the main controller 50 activates the safety mechanism 48 in response to that signal. The two controllers 42, 50 are configured to only invoke the safety mechanism when the cutting blade 13 is operating, it being understood that there is no need for the safety protocol if the cutting blade is inactive. However, the controller 50 may be configured to prevent activation of the cutting blade when the active surface 25 of the blade guard 22 is being contacted by the operator. The active surface controller 42 may thus be always active and always operable to generate a signal indicative of operator contact with the blade guard. The main controller 50 may then be configured to execute program instructions as shown in the flowchart of FIG. 4 to discern whether the cutting blade is active, in which case the safety mechanism 48 is activated upon contact with the blade guard, whether the cutting blade is inactive in which case the safety mechanism is not activated, and whether the operator is in contact with the blade guard while an attempt is made to activate the cutting blade, in which case the activation is prevented.

The active surface controller 42 may be directly electrically connected to the main controller 50 through appropriate wiring, or alternatively the signal may be communicated wirelessly between the two controllers 42, 50. Either of the controllers 42, 50 may be further configured to generate a sensible signal, such as an alarm sound, to be sensed by the operator. The safety mechanism 48 will likely have fully operated to eliminate the safety risk by the time the operator recognizes the alarm signal. Nevertheless, actuation of a sensible alarm will provide the operator with an explanation of the cause of the activation of the safety mechanism.

The active surface controller 42 may be provided with a switch 45, such as a micro-switch, that can be manually activated by the operator when the table saw is to be operated. Alternatively, the switch 45 may be configured to be automatically actuated when the blade guard 22 is pivoted downward in the direction D prior to operation of the table saw. The switch 45 may thus be arranged to one side of the mounting fork 30 to be tripped to its ‘on’ position when the blade guard is pivoted downward, and tripped to its ‘off’ position when the blade guard is pivoted upward to its idle position shown in FIG. 1. The switch 45 may be a lever-type switch or may be an optical or proximity switch configured to be tripped by movement of the blade guard relative to the mounting fork.

As a further alternative, when the blade guard 22 is installed on a riving knife, such as knife 16, the micro-switch 45 may be suppressed. The micro-switch may then be fully activated when the main power to the table saw 10 is activated. The micro-switch may also be configured to be deactivated when the saw blade 13 is no longer rotating. In either condition, operator contact with the blade guard 22 does not present a safety risk. In these alternatives, the power supply 40 may provide power to the active surface controller 42 to preliminarily activate the active surface 25 of the blade guard. However, since the micro-switch has been suppressed, the active surface controller 42 does not convey any signal to the main controller 50 to initiate the safety mechanism for the table saw. Once the micro-switch is activated and no longer suppressed, any contact by the operator with the active surface 25 will result in operation of the safety feature.

The present disclosure should be considered as illustrative and not restrictive in character. It is understood that only certain embodiments have been presented and that all changes, modifications and further applications that come within the spirit of the disclosure are desired to be protected.

What is claimed is:

1. A safety system for a power tool having a cutting blade driven by a drive motor assembly supported on a base, a safety mechanism operable by a controller to stop and/or move the cutting blade in response to a signal indicative of an unsafe condition, and a blade guard supported on the base in relation to the cutting blade, said safety system comprising:
an electrically active surface provided on the blade guard, the electrically active surface configured to change an electrical characteristic of said active surface in response to contact between the body of an operator and said active surface; and
an active surface controller operable to provide electrical power to said electrically active surface, to generate a signal in response to said change in said electrical characteristic, said signal indicative of an unsafe condition and to transmit said signal to the controller for the safety mechanism.

2. The safety system of claim 1, wherein:
said electrically active surface is a capacitive surface in which the electrical characteristic is a capacitance of said active surface; and
said active surface controller is operable to monitor said capacitance of said active surface and to generate said signal in response to a change in said capacitance.

3. The safety system of claim 1, wherein said electrically active surface is a resistive surface in which the electrical characteristic is a voltage of a layer of said resistive surface; and
said active surface controller is operable to monitor said voltage of said layer and to generate said signal in response to a change in said voltage.

4. The safety system of claim 1, in which the blade guard is supported by a mounting fork, wherein said active surface controller is carried by said mounting fork.

5. The safety system of claim 1, further comprising a power supply connected to said active surface controller.

6. The safety system of claim 5, wherein the power supply is a battery supported by the mounting fork.

7. The safety system of claim 1, wherein said active surface controller is configured to wirelessly transmit said signal to said controller for said safety mechanism.

8. The safety system of claim 1, wherein the active surface controller includes a switch actuatable to activate said active surface controller.

9. The safety system of claim 1, wherein the active surface controller includes a switch actuatable by movement of the blade guard.

10. A power tool having a cutting blade driven by a drive motor assembly supported on a base, a safety mechanism operable by a controller to stop and/or move the cutting blade in response to a signal indicative of an unsafe condition, comprising:
a blade guard supported on the base in relation to the cutting blade; and
a safety system including;
an electrically active surface provided on the blade guard, the electrically active surface configured to change an electrical characteristic of said active surface in response to contact between the body of an operator and said active surface; and
an active surface controller operable to provide electrical power to said electrically active surface, to generate a signal in response to said change in said electrical characteristic, said signal indicative of an unsafe condition and to transmit said signal to the controller for the safety mechanism.

11. The safety system of claim 10, wherein:
said electrically active surface is a capacitive surface in which the electrical characteristic is a capacitance of said active surface; and
said active surface controller is operable to monitor said capacitance of said active surface and to generate said signal in response to a change in said capacitance.

12. The safety system of claim 10, wherein said electrically active surface is a resistive surface in which the electrical characteristic is a voltage of a layer of said resistive surface; and
said active surface controller is operable to monitor said voltage of said layer and to generate said signal in response to a change in said voltage.

13. The safety system of claim 10, in which the blade guard is supported by a mounting fork, wherein said active surface controller is carried by said mounting fork.

14. The safety system of claim 10, further comprising a power supply connected to said active surface controller.

15. The safety system of claim 14, wherein the power supply is a battery supported by the mounting fork.

16. The safety system of claim 10, wherein said active surface controller is configured to wirelessly transmit said signal to said controller for said safety mechanism.

17. The safety system of claim 10, wherein the active surface controller includes a switch actuatable to activate said active surface controller.

18. The safety system of claim 17, wherein the active surface controller is configured to provide power to said active surface when the switch is not actuated.

19. The safety system of claim 10, wherein the active surface controller includes a switch actuatable by installation or movement of the blade guard.
